(19) United States
(12) Patent Application Publication
(10) Pub. No.: US 2026/0106313 A1
(43) Pub. Date: Apr. 16, 2026

(54) BATTERY ASSEMBLY INCLUDING PRISMATIC CELL CAN HAVING A MULTI-LAYER MICA VENT COVER

(71) Applicant: GM Global Technology Operations LLC, Detroit, MI (US)

(72) Inventors: Anil YADAV, Troy, MI (US); Jishn Yogeshchandra Patel, Rochester Hills, MI (US); Syed Moez Hussain Mahmood, Farmington Hills, MI (US)

(21) Appl. No.: 18/914,981

(22) Filed: Oct. 14, 2024

(51) Int. Cl. H01M 50/358; H01M 50/103; H01M 50/15; H01M 50/209; H01M 50/342; H01M 50/519

(52) U.S. Cl. CPC H01M 50/358; H01M 50/103; H01M 50/15; H01M 50/209; H01M 50/3425; H01M 50/519

(57) ABSTRACT

A battery cell including a prismatic cell can housing includes a plurality of walls forming a cell stack receiving zone, one of the plurality of walls including an opening having a first dimension. A vent is positioned across the opening. The vent is configured to open when pressure within the cell stack receiving zone exceeds a predetermined pressure value. An intercell connect board (ICB) is arranged on the one of the plurality of walls. The ICB includes a port that aligns with the opening. A multi-layer vent cover is supported on the ICB. The multi-layer vent cover includes an inner layer supported on the ICB and an outer layer supported on the inner layer. The inner layer includes a first frangible cover and the outer layer including a second frangible cover that is larger than the first frangible cover.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of battery assemblies and, more particularly, to a battery assembly including prismatic can battery cells having a muti-layer mica vent cover.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cell cans include cathode electrodes, anode electrodes, and separators arranged in a battery cell stack located in a battery cell enclosure (or cell can). The cathode electrodes include a cathode active material layer arranged on a cathode current collector. The anode electrodes include an anode active material layer arranged on an anode current collector. The cathode and anode electrodes are connected to cathode and anode terminals arranged on an outer surface of the cell can.

Battery modules are formed from multiple cell cans arranged in a housing. The anode and cathode terminals of the battery cells are connected to provide a desired output voltage. Each cell can includes a vent. The vent may be covered by a frangible lid. The vent is designed to open, and the frangible lid is designed to fail if pressure within the cell can exceeds a predetermined pressure value.

### SUMMARY

A battery cell including a prismatic cell can housing, in accordance with the present disclosure, includes a plurality of walls forming a cell stack receiving zone, one of the plurality of walls including an opening having a first dimension. A vent is positioned across the opening. The vent is configured to open when pressure within the cell stack receiving zone exceeds a predetermined pressure value. An intercell connect board (ICB) is arranged on the one of the plurality of walls. The ICB includes a port that aligns with the opening. A multi-layer vent cover is supported on the ICB. The multi-layer vent cover includes an inner layer supported on the ICB and an outer layer supported on the inner layer. The inner layer includes a first frangible cover and the outer layer including a second frangible cover that is larger than the first frangible cover.

In other features, the first frangible cover includes a first diameter, and the second frangible cover includes a second diameter, the second diameter being larger than the first diameter.

In other features, the second diameter includes a first major diameter and a first minor diameter, the first major diameter being greater than the first diameter.

In other features, wherein the first minor diameter is substantially equal to the first dimension.

In other features, wherein the first diameter is substantially equal to the first dimension.

In other features, the inner layer incudes a first structural member, and the outer layer includes a second structural member, the first frangible cover being defined by a first area of weakness formed in the first structural member and the second frangible cover being defined by a second area of weakness formed in the second structural member.

In other features, the second area of weakness rests on the first structural member when the outer layer is positioned atop the inner layer.

In other features, the multi-layer vent cover is formed from mica.

In other features, a cover extends over and spaced from the one of the plurality of walls.

A battery assembly, in accordance with the present disclosure, includes a first prismatic cell can housing including a first plurality of walls forming a first cell stack receiving zone. One of the first plurality of walls includes a first opening having a first dimension. A first vent is positioned across the first opening. The first vent is configured to open when pressure within the first cell stack receiving zone exceeds a first predetermined pressure value. A second prismatic cell can housing includes a second plurality of walls forming a second cell stack receiving zone. One of the second plurality of walls includes a second opening having a second dimension. A second vent is positioned across the second opening. The second vent is configured to open when pressure within the second cell stack receiving zone exceeds a second predetermined pressure value. An intercell connect board (ICB) is arranged on the one of the first plurality of walls and the one of the second plurality of walls. The ICB includes a first port that aligns with the first opening and a second port that aligns with the second opening. A multi-layer vent cover is supported on the ICB. The multi-layer vent cover includes an inner layer supported on the ICB and an outer layer supported on the inner layer. The inner layer includes a first frangible cover and a second frangible cover and the outer layer includes a third frangible cover and a fourth frangible cover. The third frangible cover and the fourth frangible cover being larger than corresponding ones of the first frangible cover and the second frangible cover.

In other features, the first frangible cover includes a first diameter, the second frangible cover includes a second diameter, the third frangible cover includes a third diameter, and the fourth frangible cover includes a fourth diameter, the third diameter and the fourth diameter being larger than corresponding ones of the first diameter and the second diameter.

In other features, the first prismatic cell can and the second prismatic cell can are aligned along a cell axis that runs substantially parallel to the one of the first plurality of walls and the one of the second plurality of walls.

In other features, the third diameter includes a first major diameter and a first minor diameter, and the fourth diameter includes a second major diameter and a second minor diameter, the first major diameter and the second major diameter being greater than corresponding ones of the first diameter and the second diameter.

In other features, each of the first major diameter and the second major diameter extend along axes that are substantially perpendicular relative to the cell axis.

In other features, each of the first minor diameter and the second minor diameter are substantially equal to corresponding ones of the first dimension and the second dimension.

In other features, the first diameter is substantially equal to the first dimension.

In other features, the inner layer incudes a first structural member, and the outer layer includes a second structural member, the first frangible cover being defined by a first area of weakness formed in the first structural member, the second frangible cover being defined by a second area of weakness formed in the first structural member, the third frangible cover being defined by a third area of weakness formed in the second structural member, and the fourth frangible cover being formed by a fourth area of weakness formed in the second structural member.

In other features, the third area of weakness and the fourth area of weakness rest on the first structural member when the outer layer is positioned atop the inner layer.

In other features, the multi-layer vent cover is formed from mica.

In other features, an insulating layer is formed between the first prismatic cell can and the second prismatic cell can.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of a battery assembly including prismatic cell cans having a multi-layer mica vent cover, in accordance with the present disclosure;

FIG. 2A is a top view of an outer layer of the multi-layer mica vent cover of FIG. 1, in accordance with the present disclosure;

FIG. 2B is a cross-sectional side view of the outer layer of the multi-layer mica vent cover taken through the line 2B-2B in FIG. 2A, in accordance with the present disclosure; and

FIG. 3A is a top view of an inner layer of the multi-layer mica vent cover of FIG. 1, in accordance with the present disclosure;

FIG. 3B is a cross-sectional side view of the outer layer of the multi-layer mica vent cover taken through the line 3B-3B in FIG. 3A, in accordance with the present disclosure.

FIG. 4 is a top view of the upper layer of the multi-layer vent cover arranged over the inner layer of the multi-layer vent cover, in accordance with the present disclosure;

FIG. 5 is a top view of an outer layer of the multi-layer mica vent cover of FIG. 1, in accordance with another aspect of the present disclosure; and

FIG. 6 is a top view of the upper layer of the multi-layer vent cover of FIG. 5 arranged over the inner layer of the multi-layer vent cover of FIG. 3B, in accordance with the present disclosure.

In the drawings, reference numbers may be reused to identify similar and/or identical elements.

### DETAILED DESCRIPTION

While prismatic can battery cells according to the present disclosure are described in the context of electric vehicles, the prismatic can battery cells can may be used in stationary applications and/or other applications.

The size and shape of enclosures can vary. Prismatic enclosures include a length distance, a width distance, and a height distance and may be formed as tall enclosures or long enclosures. For a tall enclosure, the height distance is greater than each of the width distance and the length distance. For long enclosures, the length distance is greater than each of the height distance and the width distance. The terminals for tall cells are typically arranged on an upper surface while the terminals for long cells may be arranged on upper or end surfaces.

Prismatic can battery cells typically include a vent cap. During a thermal runaway event, the vent cap bursts to allow at least one of vent gases and ejecta that may develop during the thermal runaway to exit the enclosure. In addition to passing through the vent, the vent gases and ejecta pass through a vent cover into a head space above the battery cells. In some cases, the vent gases and ejecta may land on adjacent vent covers and penetrate into adjacent cells triggering a chain reaction. Enhancing vent cover strength to support vent gases and ejecta from adjacent cells while still allowing gases to escape from the cell, if needed, will enhance thermal runaway mitigation for a battery assembly.

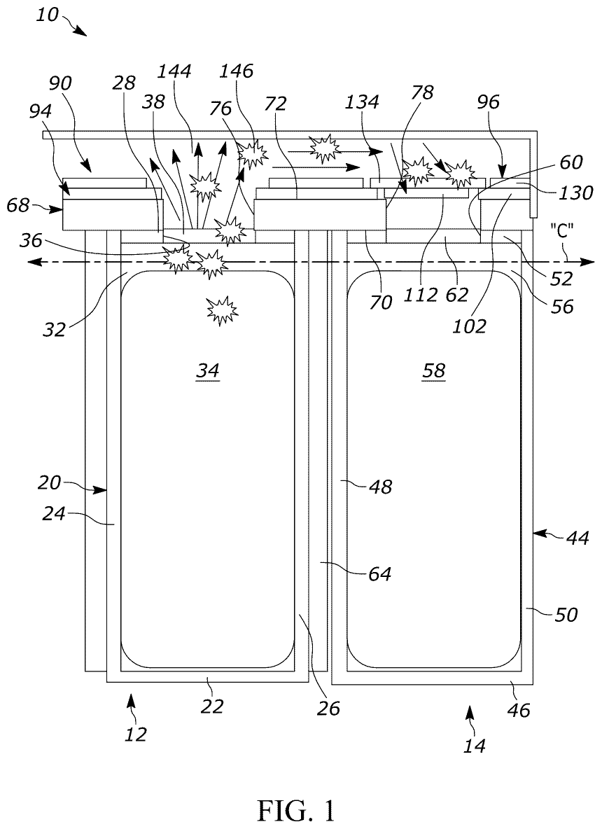

The present disclosure describes a battery assembly 10 having battery cells provided with enhanced vent cover support shown in FIG. 1. Battery assembly 10 includes a first prismatic cell can 12 arranged alongside a second prismatic cell can 14. First prismatic cell can 12 and second prismatic cell can 14 are arranged along a cell axis “C”. The number and orientation of prismatic cell cans may vary depending upon, for example, vehicle power requirements.

In accordance with the present disclosure, first prismatic cell can 12 includes a first plurality of walls 20 including a base wall 22, a first side wall 24, a second side wall 26, and a top wall 28. Base wall 22, first side wall 24, second side wall 26, and top wall 28 together with additional side walls (not shown) form a first cell stack receiving zone 32. A first cell stack 34 is arranged in first cell stack receiving zone 32. Top wall 28 includes a first opening 36 supporting a first vent 38. First opening 36 includes a first dimension.

Second prismatic cell can 14 includes a second plurality of walls 44 including a base wall portion 46, a first side wall portion 48, a second side wall portion 50, and a top wall portion 52. Base wall portion 46, first side wall portion 48, second side wall portion 50, and top wall portion 52 together with additional side wall portions (not shown) form a second cell stack receiving zone 56. A second cell stack 58 is arranged in second cell stack receiving zone 56. Top wall portion 52 includes a second opening 60 supporting a second vent 62. Second opening 60 includes a second dimension. The first dimension of first opening 36 and the second dimension of second opening 60 are substantially equal. In the non-limiting example shown in FIG. 1, an amount of insulating material 64 is disposed between second side wall 26 of first prismatic cell can 12 and first side wall portion 48 of second prismatic cell can 14. Insulating material 64 may take on various forms including, for example, aerogel.

An intercell interconnect board (ICB) 68 extends across top wall 28 and top wall portion 52. ICB 68 includes an inner surface 70 and an outer surface 72 and serves as an interface between first cell stack 34. Second cell stack 58, and an external load (not shown) such as an electric vehicle. ICB 68 includes a first port 76 and a second port 78. The number of ports vary and correlates to the number of prismatic cell cans associated with ICB 68. First port 76 aligns with first opening 36 and second port 78 aligns with second opening 60. First port 76 and second port 78 are sized to substantially correspond to the first dimension and the second dimension respectively.

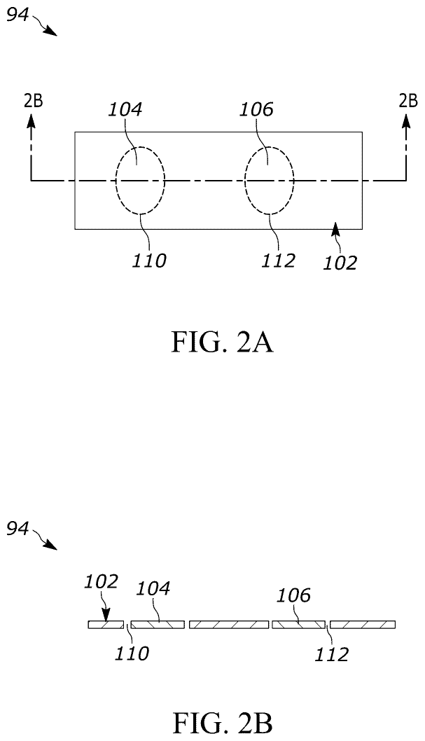

In accordance with the present disclosure, a multi-layer vent cover 90 is arranged on outer surface 72 of ICB 68. Multi-layer vent cover 90 is formed from mica and includes an inner layer 94 and an outer layer 96. While shown as having two layers, the number of layers may vary. The number of layers will be greater than a single layer. Further, while described as being formed from mica, multi-layer vent cover may be formed from other materials that may withstand pressures and temperatures associated with a thermal runaway. As shown in FIGS. 2A and 2B, inner layer 94 includes a first structural member 102 having a first frangible cover 104 and a second frangible cover 106. First frangible cover is spaced from second frangible cover 106 along cell axis “C”.

In accordance with the present disclosure, first frangible cover 104 is defined by a first area of weakness 110 formed in first structural member 102. First area of weakness 110 can take the form of perforations or a recess that extends partially through first structural member 102. Similarly, second frangible cover 106 is defined by a second area of weakness 112 formed in first structural member 102. Second area of weakness 112 can take the form of perforations or a recess that extends partially through first structural member 102. First area of weakness 110 is has an elliptical shape and includes a first major diameter and a first minor diameter. Second area of weakness 112 is likewise generally elliptical in shape and includes a second major diameter and a second minor diameter that is substantially equal to the first major diameter and the first minor diameter. Of course, the shape of the first area of weakness 110 and the second area of weakness 112 may vary.

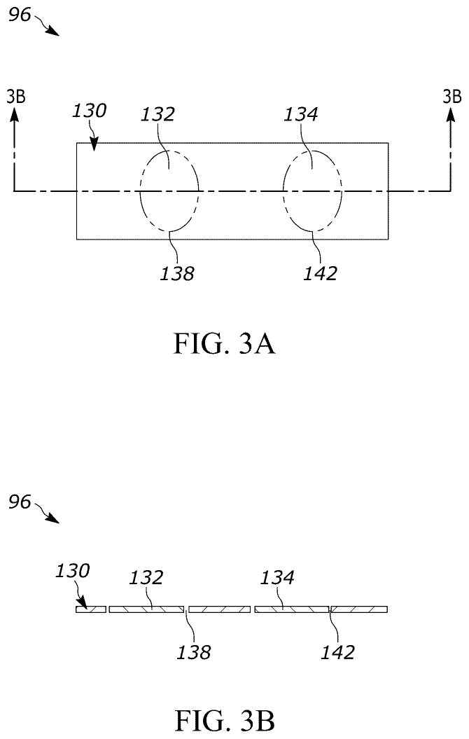

As shown in FIGS. 3A and 3B outer layer 96 includes a second structural member 130 having a third frangible cover 132 and a fourth frangible cover 134. Fourth frangible cover 134 is spaced from third frangible cover 132 along cell axis “C”. Third frangible cover 132 is defined by a third area of weakness 138. Third area of weakness 138 can take the form of perforations or a recess that extends partially through second structural member 130. Similarly, fourth frangible cover 134 is defined by a fourth area of weakness 142. Fourth area of weakness 142 can take the form of perforations or a recess that extends partially through first structural member 102.

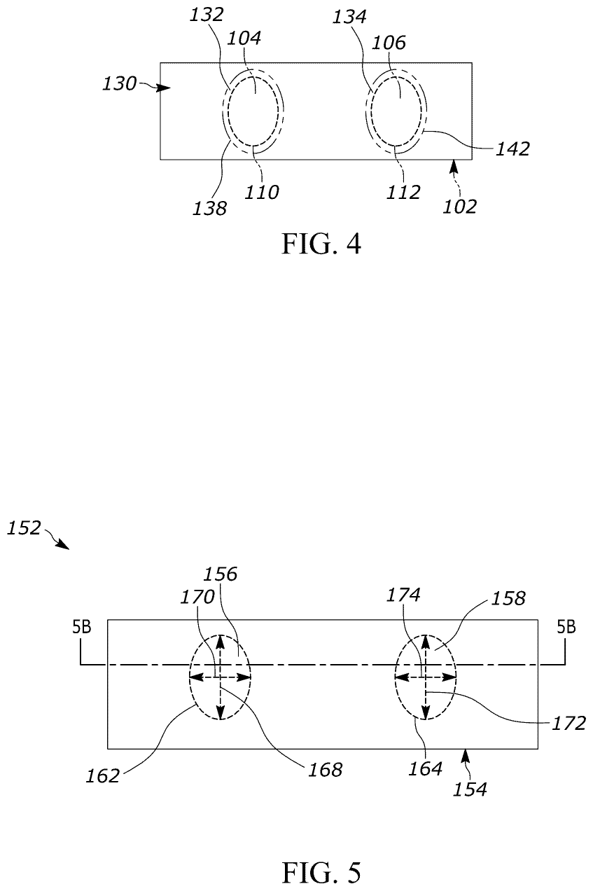

Third area of weakness 138 has an elliptical shape and includes a third major diameter and a third minor diameter. Fourth area of weakness has an elliptical shape and includes a fourth major diameter and a fourth minor diameter. In accordance with the present disclosure, the third major diameter is greater than the first major diameter and the fourth major diameter is greater than the second major diameter. With this arrangement. As shown in FIGS. 1 and 4, third frangible cover 132 is supported by first structural member 102. Likewise, fourth frangible cover 134 is supported by first structural member 102. With this construction, fourth frangible cover 134 on second prismatic cell can 14 can support forces that may be applied from above, such as gases 144 and ejecta 146 (FIG. 1) from a neighboring prismatic cell can, such as first prismatic cell can 12 but can also open when exposed to pressures from below. As first structural member 102 is formed from mica it is less likely to be affected by heat than ICB 68 which is formed from a plastic material. In this regard, first structural member 102 provides support to the frangible covers and thus reduces the likelihood that thermal runaway may propagate through the battery assembly.

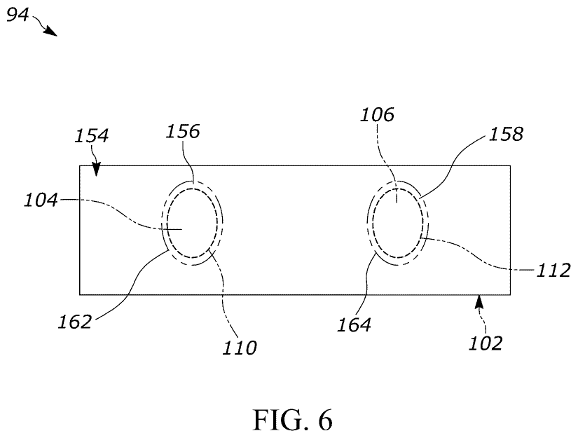

Reference will now follow to FIGS. 5 and 6 in describing an outer layer 152 in accordance with another aspect of the present disclosure. Outer layer 152 is formed from a second structural member 154 having a third frangible cover 156 and a fourth frangible cover 158. Fourth frangible cover 158 is spaced from third frangible cover 156 along cell axis “C”. In a manner similar to that discussed herein, third frangible cover 156 is defined by a third area of weakness 162 and fourth frangible cover 158 is defined by a fourth area of weakness 164.

In accordance with a non-limiting example, third frangible cover 154 has a generally elliptical shape. Likewise, fourth frangible cover 158 includes a generally elliptical shape. Third frangible cover 156 includes a first major diameter 168 and a first minor diameter 170. First major diameter 168 extends substantially perpendicularly relative to cell axis “C” while first minor diameter 170 extends substantially parallel to cell axis “C”. First major diameter 168 is larger than the first diameter of first frangible cover 104 while first minor diameter 170 is substantially equal to the first diameter of first frangible cover 104.

Likewise, fourth frangible cover 158 includes a second major diameter 172 and a second minor diameter 174. Second major diameter 172 extends substantially perpendicularly relative to cell axis “C” while second minor diameter 174 extends substantially parallel to cell axis “C”. Second major diameter 172 is larger than the second diameter of second frangible cover 106 while second minor diameter 174 is substantially equal to the second diameter of second frangible cover 106. With this construction, third frangible cover 156 and fourth frangible cover 158 includes portions that engage first structural member 102 as shown in FIG. 6. Thus, in the event of a thermal runaway in first prismatic cell can 12, fourth frangible cover 158 can support forces that may be applied from above, such as gases 144 and ejecta 146 from a neighboring prismatic cell can, such as first prismatic cell can 12 but can also open when exposed to pressures from below. In this manner, hot gases and/or ejecta resulting from a thermal runaway in one cell are less likely to breach multi-layer vent cover 90 and damage ICB 68 and/or enter into the adjacent cells triggering a thermal runaway chain reaction.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A battery cell including a prismatic cell can housing comprising:
a plurality of walls forming a cell stack receiving zone, one of the plurality of walls including an opening having a first dimension;
a vent positioned across the opening, the vent being configured to open when pressure within the cell stack receiving zone exceeds a predetermined pressure value;
an intercell connect board (ICB) arranged on the one of the plurality of walls, the ICB including a port that aligns with the opening; and
a multi-layer vent cover supported on the ICB, the multi-layer vent cover including an inner layer supported on the ICB and an outer layer supported on the inner layer, the inner layer including a first frangible cover and the outer layer including a second frangible cover that is larger than the first frangible cover.

2. The battery cell according to claim 1, wherein the first frangible cover includes a first diameter, and the second frangible cover includes a second diameter, the second diameter being larger than the first diameter.

3. The battery cell according to claim 2, wherein the second diameter includes a first major diameter and a first minor diameter, the first major diameter being greater than the first diameter.

4. The battery cell according to claim 3, wherein the first minor diameter is substantially equal to the first dimension.

5. The battery cell according to claim 2, wherein the first diameter is substantially equal to the first dimension.

6. The battery cell according to claim 1, wherein the inner layer incudes a first structural member, and the outer layer includes a second structural member, the first frangible cover being defined by a first area of weakness formed in the first structural member and the second frangible cover being defined by a second area of weakness formed in the second structural member.

7. The battery cell according to claim 6, wherein the second area of weakness rests on the first structural member when the outer layer is positioned atop the inner layer.

8. The battery cell according to claim 1, wherein the multi-layer vent cover is formed from mica.

9. The battery cell according to claim 1, further comprising: a cover extending over and spaced from the one of the plurality of walls.

10. A battery assembly comprising:
a first prismatic cell can housing including a first plurality of walls forming a first cell stack receiving zone, one of the first plurality of walls including a first opening having a first dimension;
a first vent positioned across the first opening, the first vent being configured to open when pressure within the first cell stack receiving zone exceeds a first predetermined pressure value;
a second prismatic cell can housing including a second plurality of walls forming a second cell stack receiving zone, one of the second plurality of walls including a second opening having a second dimension;
a second vent positioned across the second opening, the second vent being configured to open when pressure within the second cell stack receiving zone exceeds a second predetermined pressure value;
an intercell connect board (ICB) arranged on the one of the first plurality of walls and the one of the second plurality of walls, the ICB including a first port that aligns with the first opening and a second port that aligns with the second opening; and
a multi-layer vent cover supported on the ICB, the multi-layer vent cover including an inner layer supported on the ICB and an outer layer supported on the inner layer, the inner layer including a first frangible cover and a second frangible cover and the outer layer including a third frangible cover and a fourth frangible cover, the third frangible cover and the fourth frangible cover being larger than corresponding ones of the first frangible cover and the second frangible cover.

11. The battery assembly according to claim 10, wherein the first frangible cover includes a first diameter, the second frangible cover includes a second diameter, the third frangible cover includes a third diameter, and the fourth frangible cover includes a fourth diameter, the third diameter and the fourth diameter being larger than corresponding ones of the first diameter and the second diameter.

12. The battery assembly according to claim 11, wherein the first prismatic cell can and the second prismatic cell can are aligned along a cell axis that runs substantially parallel to the one of the first plurality of walls and the one of the second plurality of walls.

13. The battery assembly according to claim 12, wherein the third diameter includes a first major diameter and a first minor diameter, and the fourth diameter includes a second major diameter and a second minor diameter, the first major diameter and the second major diameter being greater than corresponding ones of the first diameter and the second diameter.

14. The battery assembly according to claim 13, wherein each of the first major diameter and the second major diameter extend along axes that are substantially perpendicular relative to the cell axis.

15. The battery assembly according to claim 14, wherein each of the first minor diameter and the second minor diameter are substantially equal to corresponding ones of the first dimension and the second dimension.

16. The battery assembly according to claim 12, wherein the first diameter is substantially equal to the first dimension.

17. The battery assembly according to claim 11, wherein the inner layer incudes a first structural member, and the outer layer includes a second structural member, the first frangible cover being defined by a first area of weakness formed in the first structural member, the second frangible cover being defined by a second area of weakness formed in the first structural member, the third frangible cover being defined by a third area of weakness formed in the second structural member, and the fourth frangible cover being formed by a fourth area of weakness formed in the second structural member.

18. The battery assembly according to claim 17, wherein the third area of weakness and the fourth area of weakness rest on the first structural member when the outer layer is positioned atop the inner layer.

19. The battery assembly according to claim 11, wherein the multi-layer vent cover is formed from mica.

20. The battery assembly according to claim 11, further comprising: an insulating layer formed between the first prismatic cell can and the second prismatic cell can.
